(19) United States
(12) Patent Application Publication
(10) Pub. No.: US 2020/0193221 A1
(43) Pub. Date: Jun. 18, 2020

(54) Systems, Methods, and Computer-Readable Storage Media for Designing, Creating, and Deploying Composite Machine Learning Applications in Cloud Environments

(71) Applicant: AT&T Intellectual Property I, L.P., Atlanta, GA (US)

(72) Inventors: Syed Anwar Aftab, Budd Lake, NJ (US); Kazi Farooqui, Morganville, NJ (US); Guy Jacobson, Bridgewater, NJ (US); John Murray, Denville, NJ (US); Mazin Gilbert, West Warren, NJ (US)

(73) Assignee: AT&T Intellectual Property I, L.P., Atlanta, GA (US)

(21) Appl. No.: 16/222,026

(22) Filed: Dec. 17, 2018

(51) Int. Cl. G06K 9/62; G06N 20/00; H04L 29/08

(52) U.S. Cl. CPC G06K 9/6253; H04L 67/10; G06K 9/6262; G06N 20/00

(57) ABSTRACT

Concepts and technologies disclosed herein are directed to systems, methods, and computer-readable storage media for designing, creating, and deploying composite machine learning applications in cloud environments. According to one aspect disclosed herein, a system, including a processor and memory, can present a design studio canvas upon which a user can design a composite machine learning application from at least one of a plurality of building blocks stored in a design studio catalog. The system can receive input to design, on the design studio canvas, a visual representation of the composite machine learning application. The system can save the visual representation of the composite machine learning application, and, in response to saving the visual representation of the composite machine learning application, can generate a composition dump file that includes a graph structure of the composite machine learning application.

### BACKGROUND

Machine learning is an area of computer science in which computer systems are able to learn without being explicitly programmed. Machine learning is used in many fields of science and technology from speech recognition to artificial intelligence. Machine learning and artificial intelligence have come out of the domain of researching and are quickly gaining traction to solve real life problems. Many verticals, such as, for example, banking, insurance, telecommunications, and healthcare are increasingly using machine learning and artificial intelligence to provide analytics and predictive capabilities in their respective domain. Current machine learning application development practices in these domains remain focused on two main approaches—monolithic and dedicated.

### SUMMARY

Concepts and technologies disclosed herein are directed to systems, methods, and computer-readable media for designing, creating, and deploying composite machine learning applications in cloud environments. According to one aspect of the concepts and technologies disclosed herein, a system can include a processor and memory. The memory can store instructions that, when executed by the processor, cause the processor to perform operations. In particular, the system can present a design studio canvas upon which a user can design a composite machine learning application from at least one of a plurality of building blocks stored in a design studio catalog. The system can receive input to design, on the design studio canvas, a visual representation of the composite machine learning application. The system can save the visual representation of the composite machine learning application, and, in response to saving the visual representation of the composite machine learning application, can generate a composition dump file that includes a graph structure of the composite machine learning application.

In some embodiments, the plurality of building blocks stored in the design studio catalog can include a plurality of machine learning models. The machine learning models can be onboarded to the design studio catalog by machine learning modelers. In some embodiments, the plurality of building blocks also can include one or more data collection functions. In some embodiments, the plurality of building blocks further include one or more data transformation functions.

In some embodiments, the system can validate the composition dump file based upon one or more validation rules. Upon successful validation, the system can generate, from the composition dump file, a blueprint file for the composite machine learning application, and can store the blueprint file in a repository. In some embodiments, the system can deploy, based upon the blueprint file, the composite machine learning application on one or more target cloud environments.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a block diagram illustrating aspects of an illustrative operating environment in which embodiments of the concepts and technologies disclosed herein can be implemented.

FIG. 2 is a diagram illustrating aspects of an example Topology and Orchestration Specification for Cloud Applications (“TOSCA”) model of a machine learning model, according to an illustrative embodiment.

FIG. 3A is a block diagram illustrating an example input/output (“I/O”) message configuration of a machine learning model, according to an illustrative embodiment.

FIG. 3B is a block diagram illustrating another example I/O message configuration with building blocks of a composite machine learning application (in this wrapped in a protocol buffer model runner, according to an illustrative embodiment.

FIG. 3C is a block diagram illustrating another example I/O message configuration for communications between two machine learning models, according to an illustrative embodiment.

FIGS. 4A-4B are block diagrams illustrating a design time and a run time for a composite machine learning application, according to an illustrative embodiment.

FIG. 5 is a diagram illustrating a machine learning design studio graphical user interface (“GUI”), according to an illustrative embodiment.

FIG. 6A is a directed acyclic graph (“DAG”) illustrating array-based message collation at a join port, according to an illustrative embodiment.

FIG. 6B is a DAG illustrating parameter-based message collation at a join port, according to an illustrative embodiment.

FIG. 6C is a DAG illustrating parameter-based splitting, according to an illustrative embodiment.

FIG. 6D is a DAG illustrating message splitting and multi-level collation, according to an illustrative embodiment.

FIG. 7 is a flow diagram illustrating aspects of a method for designing, creating, and deploying a composite machine learning application, according to an illustrative embodiment.

FIG. 8 is a flow diagram illustrating aspects of a method for deploying a composite machine learning application on a target cloud environment, according to an illustrative embodiment.

FIG. 9 is a flow diagram illustrating aspects of a method for executing a composite machine learning application on a target cloud environment, according to an illustrative embodiment.

FIG. 10 is a block diagram illustrating a cloud computing platform capable of implementing aspects of the concepts and technologies disclosed herein.

FIG. 11 is a block diagram illustrating a machine learning system capable of implementing aspects of the concept and technologies disclosed herein.

FIG. 12 is a block diagram illustrating an example computer system capable of implementing aspects of the embodiments presented herein.

### DETAILED DESCRIPTION

Concepts and technologies disclosed herein are directed to systems, methods, and computer-readable media for designing, creating, and deploying composite machine learning applications in cloud environments. Unlike the present methods for developing machine learning applications in which applications are developed as single, monolithic applications by integrating a patchwork of dedicated code, the concepts and technologies disclosed herein propose a novel and flexible approach to developing domain-specific machine learning applications using basic building blocks and composing the building blocks together based upon the concept of requirements exposed by one component and capabilities offered by another.

The development of customizable machine learning applications is now picking up momentum and there is a real demand for tools that help assist machine learning experts to quickly compose machine learning applications using intuitive composition mechanisms. The concepts and technologies disclosed herein describe a novel methodology used for the composition and deployment of machine learning applications on many targets, such as, for example, OPENSTACK cloud, AT&T Integrated Cloud (“AIC”), MICROSOFT AZURE cloud, and other cloud platforms.

The concepts and technologies disclosed herein provide a unique methodology of model definition, creation, and composition. The basic building blocks used for the creation of the composite machine learning applications disclosed herein undergo a unique packaging and transformation process. The methodology defines the hooks for the basic building blocks based upon whether the basic building blocks can either be connected together or not in an intuitive, graphical user interface-based machine learning design studio. Once the hooks have been defined, the building blocks can be ingested by a composition tool. The concepts and technologies disclosed herein describe a machine learning model-driven automated composition process of developing machine learning applications. Uniquely, the model-driven automated composition process uses the metadata in a machine learning model and does not rely on the user to dictate the composition of building blocks in the design studio.

The concepts and technologies disclosed herein also provide the ability to compose models developed in different programming languages and/or different machine learning toolkits. The building blocks (e.g., machine learning models) are wrapped in protocol buffer (i.e., Protobuf) model runners that enable the building blocks to be programming language and machine learning toolkit agnostic. In this manner, the machine learning models can communicate with each other irrespective of the programming language in which they were developed and/or the machine learning toolkit (e.g., Scikit Learn, Tensor Flow, or H20) used to build and train the machine learning models.

The concepts and technologies disclosed herein provide support for split and join capabilities. The design studio disclosed herein allows users not only to compose building blocks as a linear cascaded composition of heterogeneous machine learning models, but also provides the flexibility to compose directed acyclic graphs (“DAG”) based upon composite solutions where an output port can fan out into multiple outgoing links that feed other machine learning models and an input port can support a multiple fan-in capability to allow multiple machine learning models to feed their output into an input port of a machine learning model. Along with the capability to compose DAGs, the design studio supports corresponding split and join semantics. Various split and join semantics disclosed herein provide one-to-many and many-to-one connectivity semantics.

The concepts and technologies disclosed herein also provide validation, blueprint generation, and deployment. The design studio enables a validation to be performed on the composite solution before submitting the solution for cloud deployment. The design studio creates a blueprint of the validated composite solution. This blueprint is used by a deployer to deploy the composite solution in the target cloud. The metadata and operations described in the machine learning model and in the blueprint are interpreted by a cloud orchestrator to deploy the composite application in the target cloud.

The concepts and technologies disclosed herein describe independent building blocks to be chained together using a model connector. Although each building block is unaware of any other building blocks to which they might be connected at runtime, the concept of a model connector introduced herein enables communication between building blocks at run time.

The concepts and technologies disclosed herein solve at least the problem of composing a machine learning application out of pre-defined building blocks and the subsequent problem of deploying the composite machine learning application on a target cloud environment. The current state of machine learning development tends to follow an adhoc process where the entire application is developed by first developing the requisite component on an on-demand basis, and then composing the components as a patchwork of dedicated components. Currently, no notion exists of composable basic building blocks in the machine learning community. The following disclosure introduces this concept together with the concept of composition based upon metadata generated by an on-boarding mechanism associated with the design studio.

While the subject matter described herein may be presented in the general context of program modules that execute in conjunction with the execution of an operating system and application programs on a computer system, computing device, mobile device, and/or other computing resource, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

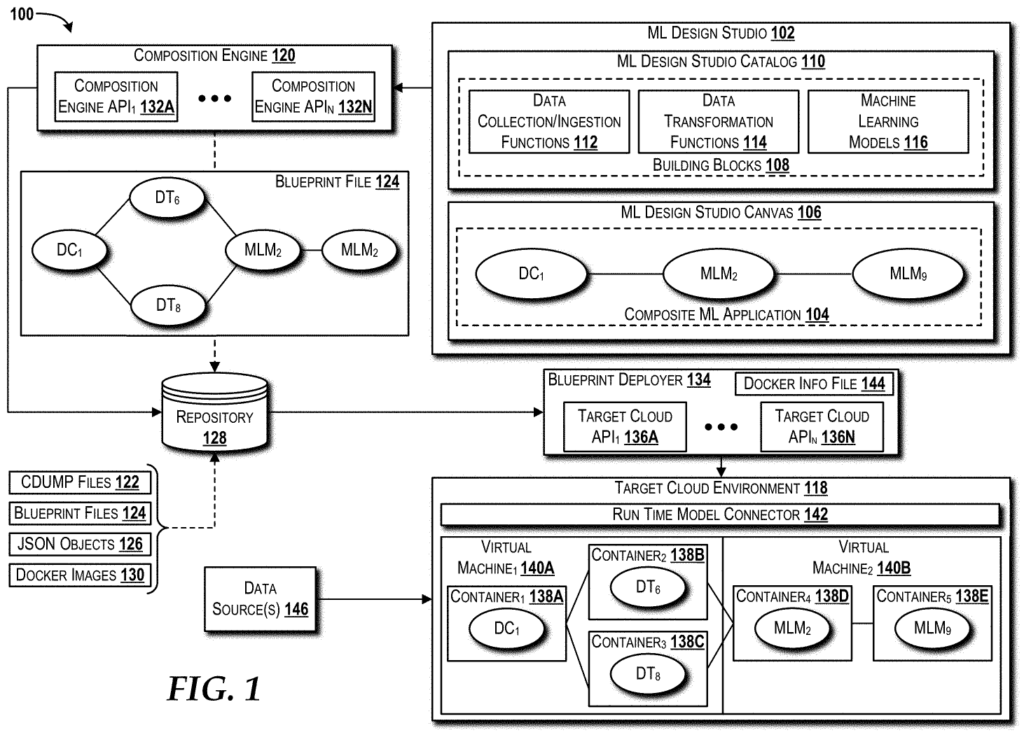

Turning now to FIG. 1, an operating environment 100 in which aspects of the concepts and technologies disclosed herein can be implemented will be described, according to an illustrative embodiment. The operating environment 100 includes a machine learning design studio (“design studio”) 102. The design studio 102 provides a visual/graphical application composition experience through which users, such as machine learning application experts/designers, can visually design composite machine learning applications 104 on a machine learning design studio canvas (“canvas”) 106 from building blocks 108 stored in a machine learning design studio catalog (“catalog”) 110. The design studio 102 enables the composition of the building blocks 108 into complete analytic applications (i.e., the composite machine learning applications 104) useful for a given purpose, such as, for example, some kind of predictive analysis or to produce a recommendation. In some embodiments, the design studio 102 is implemented as a web-based application, although the design studio 102 alternatively might be implemented as a native application running on a user's device.

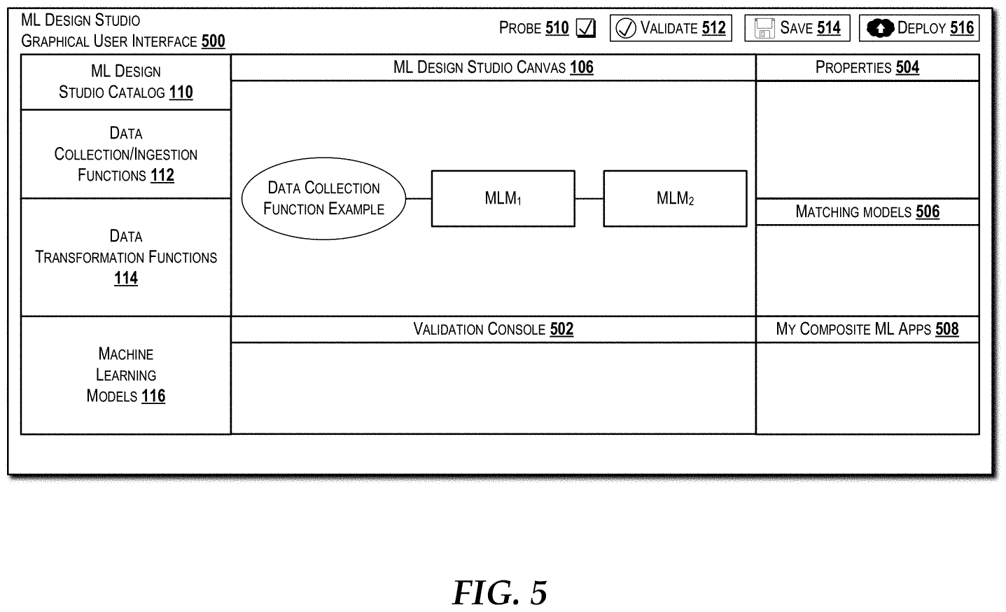

The canvas 106 provides a graphical user interface (“GUI”) design environment through which users can drag, drop, and visually compose graphical representations of the building blocks 108 into the composite machine learning applications 104. The canvas 106 also provides visual cues to guide users as to which of the building blocks 108 can be connected together. An example GUI for the design studio 102, including the canvas 106, is illustrated and described herein with reference to FIG. 5.

The illustrated building blocks 108 stored in the catalog 110 include data collection/ingestion functions 112 (e.g., data brokers), data transformation functions 114 (e.g., split, join, merge, filter, clean, normalize, and label functions), and machine learning models 116 (e.g., models that implement various algorithms, such as prediction, regression, classification, and the like). Those skilled in the art will appreciate other types of building blocks 108 that can be used to create the composite machine learning applications 104 in the design studio 102.

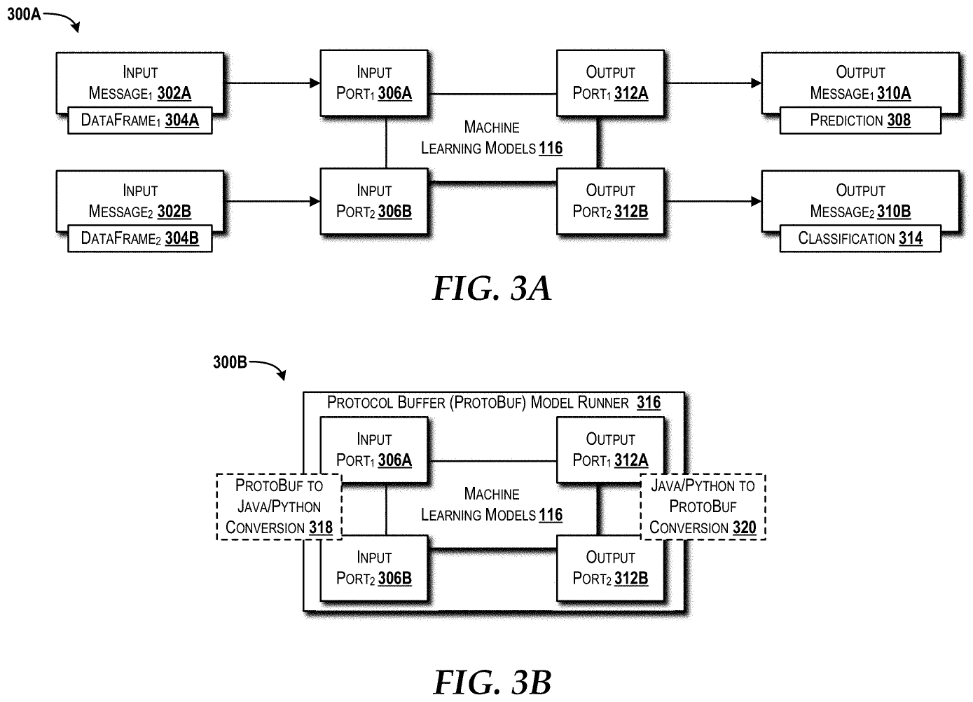

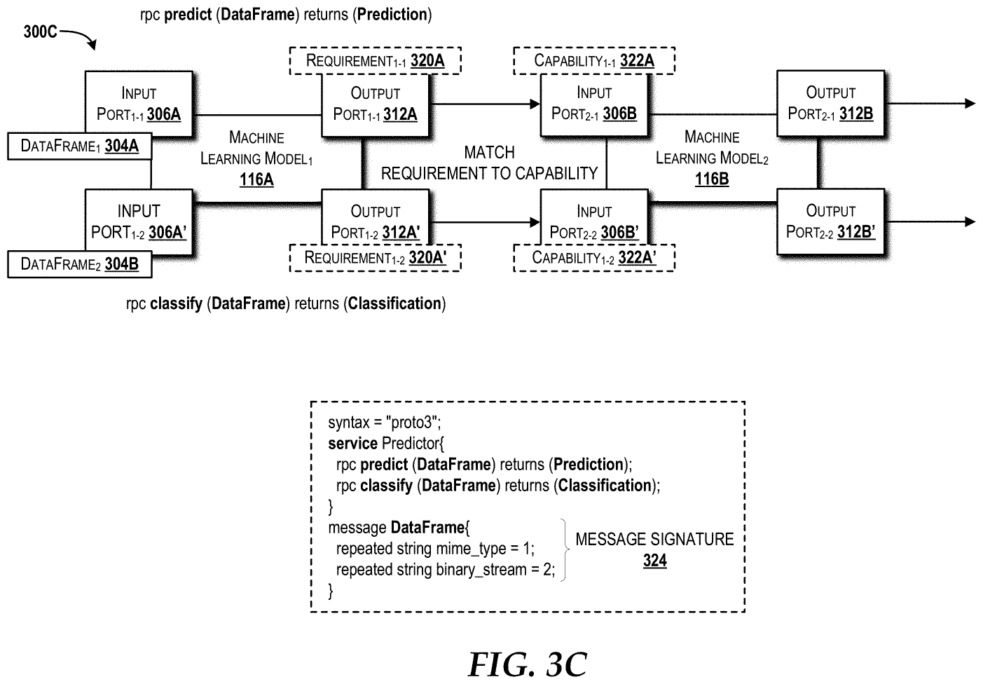

The building blocks 108 can be developed in different programming languages, such as Python, R, Java, and the like, and developed/trained in different machine learning toolkits, such as Scikit Learn, Tensor Flow, H20, and the like. The building blocks 108 are converted into microservices with well-defined application programming interface (“APIs”). In support of language heterogeneity, all communication between the machine learning models 116 are accomplished using protocol buffer (Protobuf) formatted messages. As shown in FIG. 3B, described below, each machine learning model 116 is wrapped with a model runner that converts an outgoing message into Protobuf format and each incoming Protobuf message is converted to the native language specific format. The use of model runners allows building blocks 108 developed in different programming languages to communicate with each other.

The basis of model-driven machine learning application composition is defining hooks for composition. Each of the building blocks 108 has an associated Protobuf file. A Protobuf file describes the set of operations (e.g., services) supported by a specific building block 108, and the messages that are consumed and produced by each operation. Each message is specified by a message signature, as best shown in FIG. 3C, described below. Each of the building blocks 108 is uploaded to the catalog 110 along with its Protobuf file. The message signatures of input and output messages consumed and produced by the building blocks 108 are used in the definition of hooks for composition—that is, requirements and capabilities of the building blocks 108. Each of the building blocks 108 is represented by its Topology and Orchestration Specification for Cloud Applications (“TOSCA”) model. In this manner, the building blocks 108 can be used to compose the composite ML applications 104 within the design studio 102 and to facilitate deployment on target cloud environments 118. In the TOSCA Model, each resource (i.e., one of the building blocks 108) exposes certain requirements and offers certain capabilities. These requirements and capabilities form the basis for composition and ensure only compatible hooks (i.e., ports, interfaces) are chained together.

The design studio 102 provides the frontend through which users can visually design the composite machine learning applications 104 and is supported on the backend by a composition engine 120. The composition engine 120 is a backend for composition graphs created by the design studio 102 in the canvas 106. The composition engine 120 generates composition dump (“CDUMP”) files 122 for the composite machine learning applications 104, validates the CDUMP files 122, and generates blueprint files 124.

The CDUMP files 122 are serializations of in-memory graph representations maintained by the composition engine 120 during design time. The CDUMP files 122 are simple graph structures consisting of arrays of nodes, relations, inputs, and outputs. The composition engine 120 writes these graph structures as JavaScript Object Notation (“JSON”) objects 126 that can be read back into the design studio 102 to recreate the in-memory graph representations on the canvas 106. The CDUMP files 122 contain complete information on the X and Y coordinates of nodes and links on the canvas 106, link connectivity (i.e., the nodes connected at either end of the link), and the reference to the node's TOSCA types. In response to save requests from the design studio 102, the composition engine 120 stores the CDUMP file 122 of the active design studio project in a repository 128. When a user requests to open the composite machine learning application 104 in the design studio 102, the composition engine 120 retrieves the CDUMP file 122 from the repository 128, and the UI layer of the design studio 102 interprets the CDUMP file 122 for presentation on the canvas 106.

The blueprint file 124 represents a deployment model of the composite machine learning application 104 that was designed and assembled in the canvas 106. The blueprint file 124 (i.e., deployment model) identifies the components (i.e., the building blocks 108) of the composite machine learning application 104, identifies the location from where docker images 130 of the building blocks 108 can be downloaded for deployment in the target cloud environment 118, and identifies the connectivity relationship between the components. The building blocks 108, in some embodiments, are standard microservices that expose standard representational state transfer (“REST”)-based interfaces. The building blocks 108 each consumes an input message and produces an output message. The building blocks 108 are not aware of their environment—that is, each of the building blocks 108 do not know to which other building blocks they might be connected during run time. At design time, the design studio 102 captures this connectivity information in the blueprint file 124. The connectivity information identifies the sequence in which the building blocks 108 need to be invoked.

The composition engine 120 contains and maintains in-memory graph representations that respond to editing operations performed in the design studio 102 on the canvas 106 to perform editing operations, such as, for example, adding nodes and links, deleting nodes and links, modifying node and link properties. The composition engine 120 exposes composition engine APIs 132A-132N for the UI layer of the design studio 102 to call for performing all user-requested action in the UI layer, such as, for example, retrieving all of the building blocks 108 and the composite machine learning application 104 from the repository 128 into the UI layer; adding, deleting, or modifying nodes and/or links; saving the composite machine learning application 104; validating the composite machine learning application 104; and retrieving the composite learning applications 104. Operations such as these update the graph structures in the CDUMP file 122.

A blueprint deployer 134 retrieves the blueprint file 124 of the composite machine learning application 104 from the repository 128. The blueprint deployer 134 retrieves the docker images 130 of the building blocks 108 from the URLs specified in the blueprint file 124. The blueprint deployer 134 utilizes target cloud APIs 136A-136N to create, based upon the docker images 130, docker containers (“containers”) 138A-138E on virtual machines 140A-140B in the target cloud environment 118, and assigns IP addresses and ports to the containers 138A-138E. The blueprint deployer 134 provides model chaining information to a run time model connector 142 based upon the connectivity information in the blueprint file 124. The blueprint deployer 134 then starts the containers 138A-138E. The blueprint deployer 134 creates a docker information file 144 that contains the associations between the building blocks 108 of the composite machine learning application 104 and the IP addresses and ports of the containers 138A-138E.

Execution of the composite machine learning application 104 is facilitated by the run time model connector 142. The run time model connector 142 enables communication between the building blocks 108 of the composite machine learning application 104. The blueprint file 124 (produced by the composition engine 120) and the docker information file 144 (produced by the blueprint deployer 134) are fed to the run time model connector 142, which interprets the connectivity information provided in the blueprint file 124, assigns IP addresses and ports to the building blocks 108, and feeds the output of one building block 108 to the input of the next building block 108. The building block(s) 108 of the composite machine learning application 104 that is/are responsible for performing the data collection/ingestion function(s) 112 can point to one or more data sources 146 from which to collect/ingest data for the composite machine learning application 104 during run time.

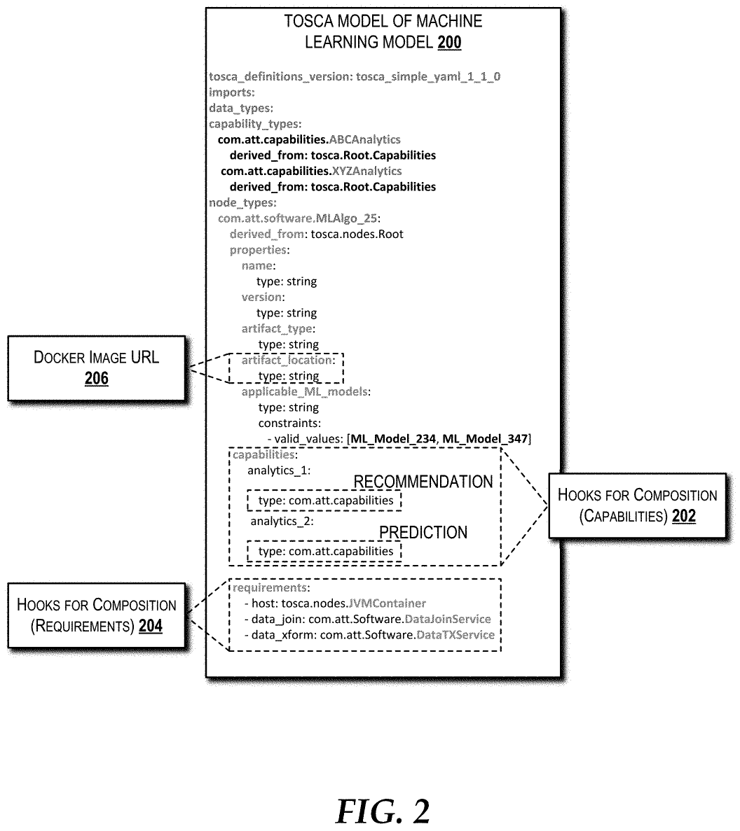

Turning now to FIG. 2, an example TOSCA model 200 of one of the machine learning models 116 will be described, according to an illustrative embodiment. The TOSCA model 200 defines the hooks for composition, including capabilities 202 and requirements 204 of the machine learning model 116. The TOSCA model 200 also identifies a docker image URL 206 for the machine learning model 116. As explained above, the blueprint deployer 134 downloads the associated docker image 130 from the repository 128 and deploys it in the container 138 on the VM 140 in the target cloud environment 118, in accordance with the requirements 204.

Turning now to FIG. 3A, a block diagram illustrating an example I/O message configuration 300A of the machine learning models 116 will be described, according to an illustrative embodiment. The illustrated I/O configuration 300A includes input messages 302A-302B each having a dataframe 304A-304B provided to the machine learning models 116 via input ports 306A, 306B assigned by the blueprint deployer 134. In particular, the input message 302A includes the dataframe 304A used as input to a prediction model of the machine learning models 116 via the input port 306A to create a prediction 308 provided in an output message 310A output by an output port 312A. Similarly, the input message 302B includes the dataframe 304B used as input via a classification model of the machine learning models 116 via the input port 306B to create a classification 314 provided in an output message 310B output by an output port 312B.

Turning now to FIG. 3B, a block diagram illustrating another example I/O message configuration 300B with the building blocks 108 (in this example the machine learning models 116) wrapped in a protocol buffer (“Protobuf”) model runner 316 will be described, according to an illustrative embodiment. This enables the machine learning models 116 to communicate with each other irrespective of the programming language (e.g., Python, Java, R, and the like) in which the machine learning models 116 were developed and/or the machine learning toolkit used to build and train the machine learning models 116. In the illustrated example, the Protobuf model runner 316 enables the machine learning models 116 to communicate with building blocks 108 developed in Java or Python. On the input side, the Protobuf model runner 316 provides a Protobuf to Java/Python conversion 318, and, on the output side, the Protobuf model runner 316 provides a Java/Python to Protobuf conversion 320. In this manner, the machine learning models 116 developed in Java and/or Python can communicate with other building blocks 108 that are similarly wrapped with the Protobuf model runner 316 to facilitate heterogeneity among the building blocks 108 of a given composite machine learning application 104.

Turning now to FIG. 3C, a block diagram illustrating another I/O message configuration 300C for communications between two machine learning models 116A, 116B will be described, according to an illustrative embodiment. The illustrated I/O configuration 300C shows the machine learning model₁ 116A with two input ports 306A, 306A′ and two output ports 312A, 312A′, and the machine learning model₂ 116B with two input ports 306B, 306B′ and two output ports 312B, 312B′. The output ports 312A, 312A′ of the machine learning model₁ 116A produce requirements 320A, 320A′ (i.e., hooks for composition (requirements) 204—see FIG. 2) that are matched to capabilities 322A, 322A′ (i.e., hooks for composition (capabilities) 202) of the input ports 306B, 306B′ of the machine learning model₂ 116B. A message signature 324 representative of the dataframe 304A, 304B fed to the machine learning model₁ 116A is also shown.

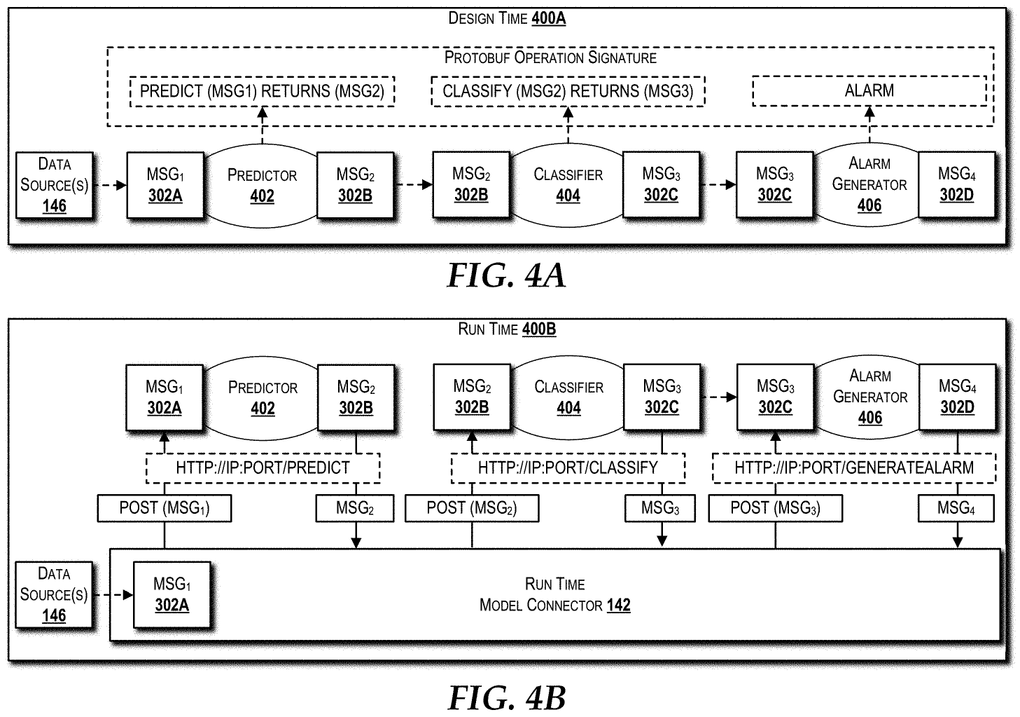

Turning now to FIGS. 4A-4B, block diagrams illustrating a design time 400A and a run time 400B for the composite machine learning application 104 will be described, according to an illustrative embodiment. The FIGS. 4A-4B will be described with additional reference to FIGS. 1 and 3A-3C.

Referring first to FIG. 4A, the design time 400A illustrates a predictor 402, a classifier 404, and an alarm generator 406 as example building blocks 108 of an example composite machine learning application 104. The predictor 402 receives a first message (MSG₁) 302A that includes data from the data source(s) 146, performs its prediction 308 operation, and returns a second message (MSG₂) 302B. The classifier 404 receives the second message (MSG₂) 302B as output from the predictor 402, performs its classification 314 operation, and returns a third message (MSG₃) 302C. The alarm generator 406 receives the third message (MSG₃) 302C as output from the classifier 404, performs its alarm generation operation, and returns a fourth message (MSG₄) 302D that includes the alarm.

Referring now to FIG. 4B, the run time 400B illustrates the predictor 402, the classifier 404, and the alarm generator 406 as configured during the design time 400A of the composite machine learning application 104. Although the predictor 402, the classifier 404, and the alarm generator 406 are unaware of each other, these building blocks 108 are connected during the run time 400B by the run time model connector 142. The run time model connector 142 receives the blueprint file 124 (produced by the composition engine 120) and the docker information file 144 (produced by the blueprint deployer 134) from the blueprint deployer 134. The run time model connector 142 orchestrates the execution of the composite machine learning application 104 in the target cloud environment 118, in accordance with the blueprint file 124 and the docker information file 144. The run time model connector 142 calls the required building blocks 108 of the composite machine learning application 104 using the URLs of the docker images 130 associated therewith, and communicates the messages 302 between the building blocks 108 via HTTP POST as shown.

Turning now to FIG. 5, a machine learning design studio GUI (“design studio GUI”) 500 will be described, according to an illustrative embodiment. The design studio GUI 500 shows a graphical representation of the catalog 110 from which users can select graphical representations of the building blocks 108—that is, the data collection/ingestion functions 112, the data transformation functions 114, and the machine learning models 116 to design the composite machine learning application 104 on the canvas 106.

The design studio GUI 500 also shows a validation console 502, a properties box (“properties”) 504, a matching models box (“matching models”) 506, a My Composite Machine Learning Applications box 508, a probe checkbox 510 a validate option 512, a save option 514, and a deploy option 516. The properties box 504 provides a view of the properties of the building blocks 108, the operations exposed thereby (via ports), and the details of the message signatures associated therewith. When a user clicks on an input or output port of a given building block 108, all the machine learning models 116 that are compatible with that port and can be connected to that port are displayed in the matching models box 506. The user can then drag visual representations of the machine learning models 116 that are compatible into the canvas 106 for composition. The composite machine learning applications 104 created by the user but not yet made public are shown in the My Composite Machine Learning Applications box 508. The user can drag and drop them from this box into the canvas 106 and update as needed. The design studio GUI 500 allows the user to insert a probe capability between a pair of ports. When the probe checkbox 510 is checked, at run time, the run time model connector 142 will forward any message flowing between a pair of ports to a probe, where it can be visualized by the user. The save option 514 allows the user to save the current design shown on the canvas 106. Selection of the save option 514 prompts the composition engine 120 to create the CDUMP file 122 for the current design and to stores the CDUMP file 122 in the repository 128. Once the composite machine learning application 104 is saved, the user can click on the validate option 512, which prompts the composition engine 120 to execute a set of validation rules to validate the composite machine learning application 104. If the composite machine learning application 104 is successfully validated, the composition engine 120 creates the blueprint file 124 for the composite machine learning application 104 and stores the blueprint file 124 in the repository 128 for later use by the blueprint deployer 134. All validation-related errors and/or success messages and other information can be presented to the user in the validation console 502. The deploy option 516 remains greyed out and gets activated only if the validation was successful. When clicked, the user can be directed to a deployment interface to initiate deployment of the composite machine learning application 104.

The design studio 102 lets the user not only compose the building blocks 108 as a linear cascaded composition of heterogeneous machine learning models, but also provides the flexibility to compose DAG-based composite solutions where an output port of one model might fan out into multiple outgoing links feeding other models and an input port that support multiple fan-in capability to allow multiple models to feed their outputs into an input port of the model. Along with this capability, the design studio 102 supports corresponding split and join (collation) semantics that are used to provide one-to-many and many-to-one connectivity between models.

The use of DAG topology by the design studio 102 operates under the assumption that each model in the composite machine learning application 104 consumes one message (i.e., an input message 302) and produces one message (i.e., an output message 310). The design studio 102 also follows REST-based communication standards to maintain a single request to single response communication style. In some embodiments, the data source(s) 146 send REST requests directly to the composite machine learning application 104 during run time. Alternatively, in other embodiments, one or more data brokers are leveraged to retrieve data from the data source(s) 146 and to supply that data to the composite machine learning application 104.

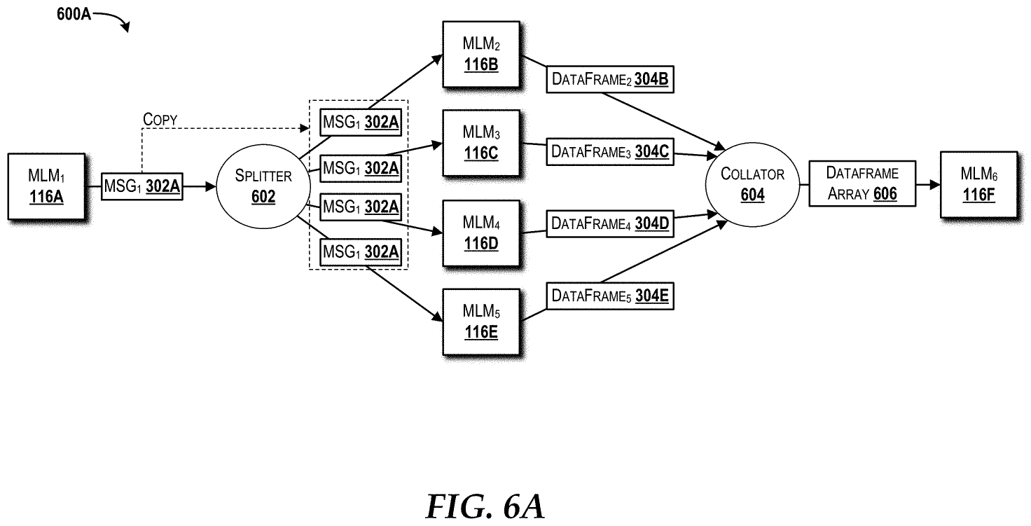

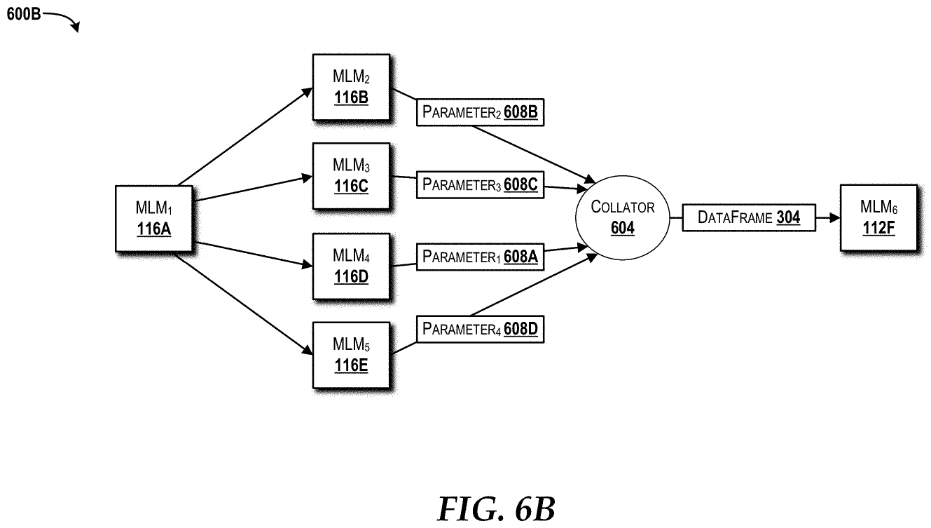

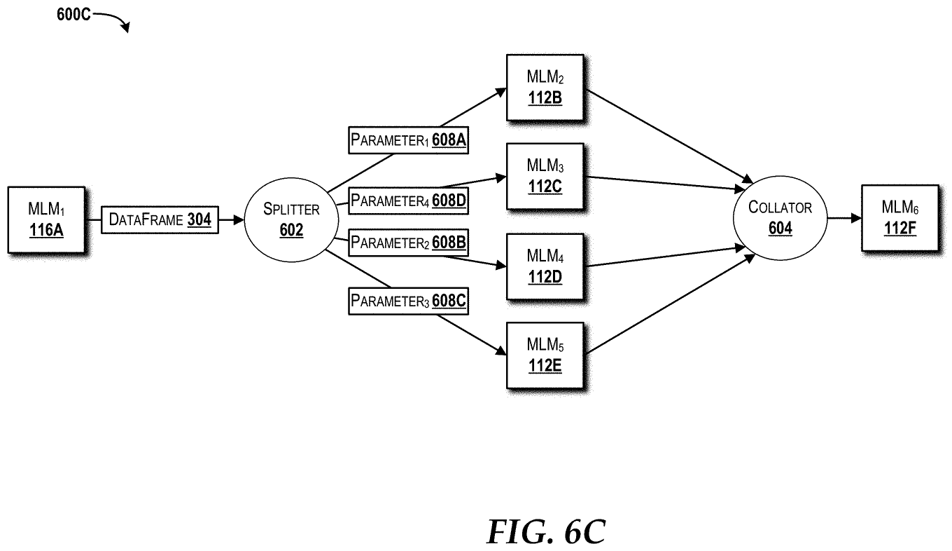

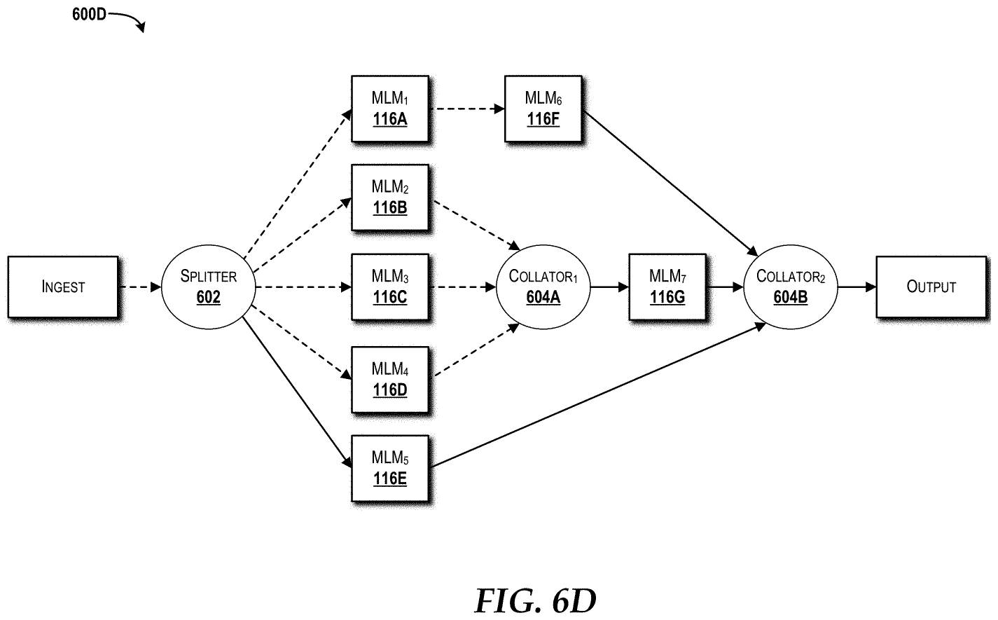

Turning now to FIG. 6A, a directed acyclic graph (“DAG”) 600A illustrating array-based message collation at a join port will be described, according to an illustrative embodiment. In the illustrated example, the machine learning models 116A provides the message₁ 302A to a splitter function (“splitter”) 602. The splitter 602 copies the message₁ 302A and creates links from the machine learning model₁ 116A to the other machine learning models 116B-116E—the machine learning model₂ 116B, the machine learning models 116C, the machine learning model₃ 116C, the machine learning model₄ 116D, and the machine learning model₅ 116E. The join port (i.e., a collator 604) supports the repeated dataframe 304 (itself a complex/nested message structure). Each incoming link to the collator 604 provides a single dataframe 304 as output from one of the machine learning models 116B-116D. The collator 604 combines (i.e., collates/joins) the single dataframes 304 received from each of the machine learning models 116 into an array of the dataframes 304, shown as a dataframe array 606. The collator 604 ensures that the dataframes 304 supplied by the incoming links and the dataframe supported on the join port both have the same message signature 324, otherwise collation is not allowed. The collator 604 presents the dataframe array 606 on the output port for ingestion by the input port of the target machine learning model—the machine learning model₆ 116F. The collator 604 waits until all input message are received on the incoming links. The collator 604 provides the message synchronization, and hence support for REST-style request/response semantics.

Turning now to FIG. 6B, a DAG 600B illustrating parameter-based message collation at a join port will be described, according to an illustrative embodiment. In the illustrated example, each incoming link to the collator 604 provides partial message data, represented as parameters 608 of the message type. The join port (i.e., the collator 604) supports non-repeated dataframes. The collator 604 ensures that the parameter types provided by the incoming links are compatible with the parameter types supported at the join port, otherwise collation is not allowed. The collator 604 combines the parameters 608 into a single dataframe 304, as per the target message signature specification. The collator 604 waits until it receives all of the parameters 608 of the message signature 324. The collator 604 provides the synchronization, and hence support for REST-style request/response semantics. Parameter collation is performed only at the first/top level of the target message signature 324. In the case that each source (e.g., the machine learning models 116B-116E) provides a single parameter 608, the collator 604 needs to understand which source supplies which parameter type. The association between source parameters target parameters is supplied by the modeler of the machine learning model 116 during design time.

Turning now to FIG. 6C, a DAG 600C illustrating parameter-based splitting will be described, according to an illustrative embodiment. In the illustrated example, the machine learning model₁ 116A provides the dataframe 304 to the splitter 602, which splits the dataframe 304 into the parameters 608. The splitter 602 feeds one of the parameters 608A-608D to the machine learning models 116B-116E, the output of which is then collated by the collator 604 and fed to the final machine learning model—the machine learning model₆ 116F.

Turning now to FIG. 6D, a DAG 600D illustrating message splitting and multi-level collation will be described, according to an illustrative embodiment. In the illustrated example, the splitter 602 ingests and splits a message among the machine learning models 112A-112E. The machine learning model₁ 112A provides output to the machine learning model₆ 112F that, in turn, provides output to a second collator (“collator₂”) 604B. The machine learning models 112B-112D provide output to the first collator (“collator₁”) 604A, which collates these outputs for input into the machine learning model₇ 112G. The collator₂ 604B receives the output of the machine learning model₆ 112G, the machine learning model₇ 112G, and the machine learning models 112E and collates these outputs into the final output of the composite solution.

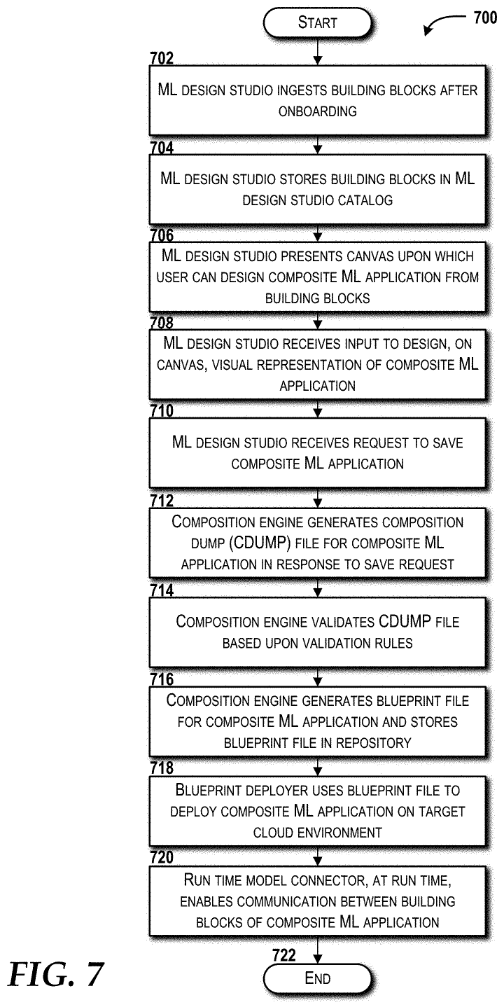

Turning now to FIG. 7, aspects of a method 700 for designing, creating, and deploying the composite machine learning application 104 will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof are used to refer to causing one or more processors to perform operations.

For purposes of illustrating and describing some of the concepts of the present disclosure, the methods disclosed herein are described as being performed, at least in part, by one or more processors executing instructions for implementing the concepts and technologies disclosed herein. It should be understood that additional and/or alternative systems, devices and/or network nodes can provide the functionality described herein via execution of one or more modules, applications, and/or other software. Thus, the illustrated embodiments are illustrative, and should not be viewed as being limiting in any way.

The method 700 begins and proceeds to operation 702, where the design studio 102 ingests the building blocks 108 after onboarding. From operation 702, the method 700 proceeds to operation 704, where the design studio 102 stores the building blocks in the catalog 110. From operation 704, the method 700 proceeds to operation 706, where the design studio 102 presents the canvas 106 upon which the user can visually design the composite machine learning application 104 from visual representations of the building blocks 108. From operation 706, the method 700 proceeds to operation 708, where the design studio 102 receives input from the user to design, on the canvas 106, a visual representation of the composite machine learning application 104 from the building blocks 108 available in the catalog 110. From operation 708, the method 700 proceeds to operation 710, where the design studio 102 receives a request to save (e.g., via the save option 514 shown in the design studio GUI 500—see FIG. 5) the composite machine learning application 104.

In response to the save request received at operation 710, the composition engine 120 (i.e., the backend processing portion of the design studio 102) generates, at operation 712, the CDUMP file 122 for the composite machine learning application 104. From operation 712, the method 700 proceeds to operation 714, where the composition engine 120 validates the CDUMP file 122 based upon one or more validation rules. Results of the validation operation can be presented in the validation console 502 shown in FIG. 5. From method 700 ends if the composition engine 120 is unable to validate the CDUMP file 122. From operation 714, the method 700 proceeds to operation 716, where the composition engine 120 generates the blueprint file 124 for the composite machine learning application 104 and stores the blueprint file in the repository 128.

From operation 716, the method 700 proceeds to operation 718, where the blueprint deployer 134 uses the blueprint file 124 to deploy the composite machine learning application 104 in the target cloud environment 118. From operation 718, the method 700 proceeds to operation 720, where the run time model connector 142, at run time (such as illustrated as 400B in FIG. 4B), enables communication between the building blocks 108 of the composite machine learning application 104 based upon the docker information file 144 provided by the blueprint deployer 134. From operation 720, the method 700 proceeds to operation 722, where the method 700 ends.

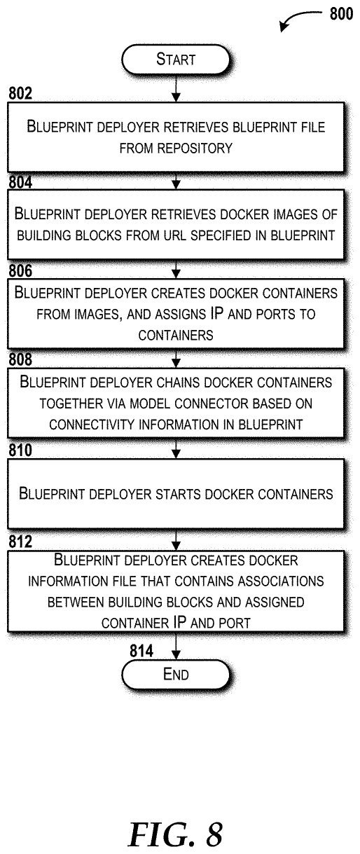

Turning now to FIG. 8, a method 800 for deploying the composite machine learning application 104 in the target cloud environment 118 will be described, according to an illustrative embodiment. The method 800 begins with a request (not shown) to deploy received from the user by the design studio 102 and proceeds to operation 802, where the blueprint deployer 134 retrieves the blueprint file 124 from the repository 128. From operation 802, the method 800 proceeds to operation 804, where the blueprint deployer 134 retrieves the docker images 130 of the building blocks 108 from the URLs specified in the blueprint file 124. From operation 804, the method 800 proceeds to operation 806, where the blueprint deployer 134 creates the containers 138 from the docker images 130, and assigns IP addresses and ports to the containers 138. From operation 806, the method 800 proceeds to operation 808, where the blueprint deployer 134 chains the containers 138 together, via the run time model connector 142, based upon the connectivity information provided in the blueprint file 124. From operation 810, the blueprint deployer 134 starts the containers 138 in the virtual machines 140 deployed in the target cloud environment 118. From operation 810, the method 800 proceeds to operation 812, where the blueprint deployer 134 creates the docker information file 144 that contains associations between the building blocks 108 and the assigned container's IP address(es) and port(s). From operation 812, the method 800 proceeds to operation 814, where the method 800 ends.

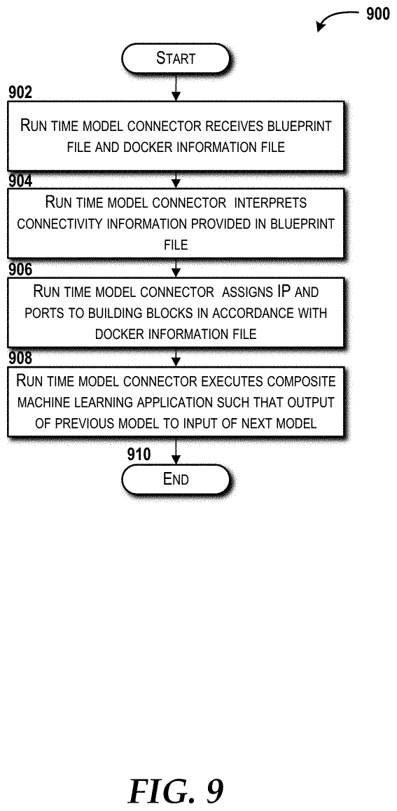

Turning now to FIG. 9, a method 900 for executing the composite machine learning application 104 in the target cloud environment 118 will be described, according to an illustrative embodiment. The method 900 begins and proceeds to operation 902, where the run time model connector 142 receives the blueprint file 124 and the docker information file 144 from the blueprint deployer 134. From operation 902, the method 900 proceeds to operation 904, where the run time model connector 142 interprets the connectivity information provided in the blueprint file 124. From operation 904, the method 900 proceeds to operation 906, where the run time model connector 142 assigns IP address(es) and port(s) to the building blocks 108 in accordance with the docker information file 144. From operation 906, the method 900 proceeds to operation 908, where the run time model connector 142 executes the composite machine learning application 104 such that the output of previous machine learning models 116 is fed into the input of next machine learning models 116 in a sequence as dictated by the blueprint file 124. From operation 908, the method 900 proceeds to operation 910, where the method 900 ends.

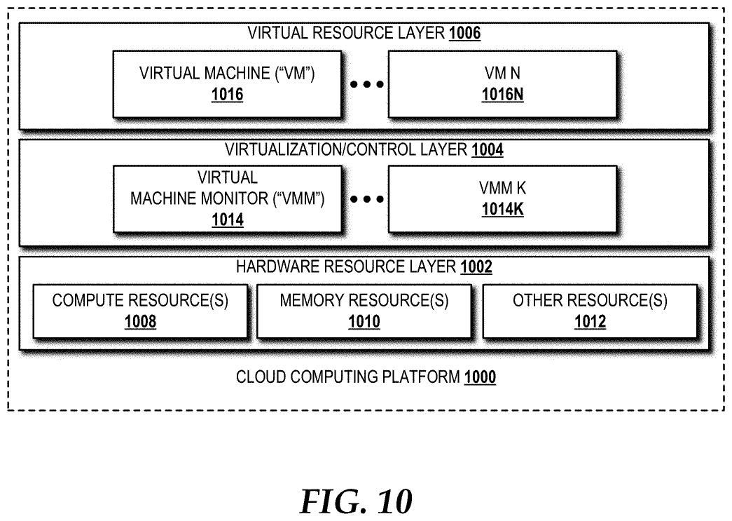

Turning now to FIG. 10, a cloud computing platform 1000 capable of implementing aspects of the concepts and technologies disclosed herein will be described, according to an illustrative embodiment. In some embodiments, the target cloud environment 118 is configured, at least in part, like the cloud computing platform 1000. Those skilled in the art will appreciate that the illustrated cloud computing platform 1000 is a simplification of but one possible implementation of the target cloud environment 118, and as such, the cloud computing platform 1000 should not be construed as limiting in any way. In some embodiments, the design studio 102, the composition engine 120, the blueprint deployer 134, the run time model connector 142, any user/designer/modeler systems, and other systems disclosed herein can be implemented, at least in part, by the cloud computing platform 1000.

The illustrated cloud computing platform 1000 includes a hardware resource layer 1002, a virtualization/control layer 1004, and a virtual resource layer 1006 that work together to perform operations as will be described in detail herein. While connections are shown between some of the components illustrated in FIG. 10, it should be understood that some, none, or all of the components illustrated in FIG. 10 can be configured to interact with one other to carry out various functions described herein. In some embodiments, the components are arranged so as to communicate via one or more networks (not shown). Thus, it should be understood that FIG. 10 and the following description are intended to provide a general understanding of a suitable environment in which various aspects of embodiments can be implemented, and should not be construed as being limiting in any way.

The hardware resource layer 1002 provides hardware resources, which, in the illustrated embodiment, include one or more compute resources 1008, one or more memory resources 1010, and one or more other resources 1012. The compute resource(s) 1008 can include one or more hardware components that perform computations to process data, and/or to execute computer-executable instructions of one or more application programs, operating systems, and/or other software. The compute resources 1008 can include one or more central processing units (“CPUs”) configured with one or more processing cores. The compute resources 1008 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 1008 can include one or more discrete GPUs. In some other embodiments, the compute resources 1008 can include CPU and GPU components that are configured in accordance with a co-processing CPU/GPU computing model, wherein the sequential part of an application executes on the CPU and the computationally-intensive part is accelerated by the GPU. The compute resources 1008 can include one or more system-on-chip (“SoC”) components along with one or more other components, including, for example, one or more of the memory resources 1010, and/or one or more of the other resources 1012. In some embodiments, the compute resources 1008 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 1008 can be or can include one or more hardware components architected in accordance with an ARM architecture, available for license from ARM HOLDINGS of Cambridge, United Kingdom. Alternatively, the compute resources 1008 can be or can include one or more hardware components architected in accordance with an x86 architecture, such an architecture available from INTEL CORPORATION of Mountain View, Calif., and others. Those skilled in the art will appreciate the implementation of the compute resources 1008 can utilize various computation architectures, and as such, the compute resources 1008 should not be construed as being limited to any particular computation architecture or combination of computation architectures, including those explicitly disclosed herein.

The memory resource(s) 1010 can include one or more hardware components that perform storage operations, including temporary or permanent storage operations. In some embodiments, the memory resource(s) 1010 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 1008.

The other resource(s) 1012 can include any other hardware resources that can be utilized by the compute resources(s) 1008 and/or the memory resource(s) 1010 to perform operations described herein. The other resource(s) 1012 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resources layer 1002 can be virtualized by one or more virtual machine monitors (“VMMs”) 1014A-1014K (also known as “hypervisors”; hereinafter “VMMs 1014”) operating within the virtualization/control layer 1004 to manage one or more virtual resources that reside in the virtual resource layer 1006. The VMMs 1014 can be or can include software, firmware, and/or hardware that alone or in combination with other software, firmware, and/or hardware, manages one or more virtual resources operating within the virtual resource layer 1006.

The virtual resources operating within the virtual resource layer 1006 can include abstractions of at least a portion of the compute resources 1008, the memory resources 1010, the other resources 1012, or any combination thereof. These abstractions are referred to herein as virtual machines (“VMs”). In the illustrated embodiment, the virtual resource layer 1006 includes VMs 1016A-1016N (hereinafter “VMs 1016”) (such as the VMs 140A, 140B in FIG. 1). As explained above, the VMs 140A-140B can execute, within the containers 138A-138E, the building blocks 108 of the composite machine learning application 104 deployed in the target cloud environment 118.

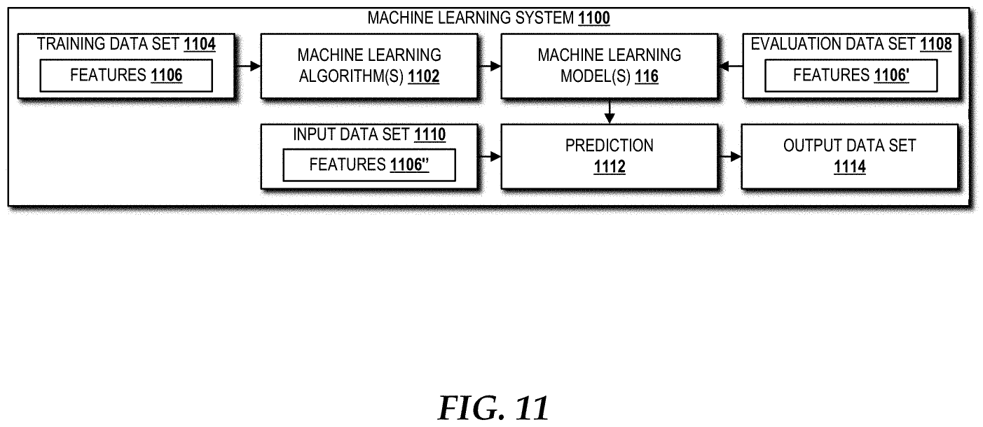

Turning now to FIG. 11, a machine learning system 1100 capable of implementing aspects of the embodiments disclosed herein will be described. The illustrated machine learning system 1100 includes one or more machine learning models 116. The machine learning model(s) 116 can be created by the machine learning system 1100 based upon one or more machine learning algorithms 1102. The machine learning algorithm(s) 1102 can be any existing, well-known algorithm, any proprietary algorithms, or any future machine learning algorithm. Some example machine learning algorithms 1102 include, but are not limited to, gradient descent, linear regression, logistic regression, linear discriminant analysis, classification tree, regression tree, Naive Bayes, K-nearest neighbor, learning vector quantization, support vector machines, and the like. Those skilled in the art will appreciate the applicability of various machine learning algorithms 1102 based upon the problem(s) to be solved by machine learning via the machine learning system 1100.

The machine learning system 1100 can control the creation of the machine learning models 116 via one or more training parameters. In some embodiments, the training parameters are selected by one or more users, such as the modelers that onboard their machine learning models 116 into the catalog 110. Alternatively, in some embodiments, the training parameters are automatically selected based upon data provided in one or more training data sets 1104. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 1102 converges to the optimal weights. The machine learning algorithm 1102 can update the weights for every data example included in the training data set 1104. The size of an update is controlled by the learning rate. A learning rate that is too high might prevent the machine learning algorithm 1102 from converging to the optimal weights. A learning rate that is too low might result in the machine learning algorithm 1102 requiring multiple training passes to converge to the optimal weights.

The model size is regulated by the number of input features (“features”) 1106 in the training data set 1104. A greater the number of features 1106 yields a greater number of possible patterns that can be determined from the training data set 1104. The model size should be selected to balance the resources (e.g., compute, memory, storage, etc.) needed for training and the predictive power of the resultant machine learning model 116.

The number of training passes indicates the number of training passes that the machine learning algorithm 1102 makes over the training data set 1104 during the training process. The number of training passes can be adjusted based, for example, on the size of the training data set 1104, with larger training data sets being exposed to fewer training passes in consideration of time and/or resource utilization. The effectiveness of the resultant machine learning model 116 can be increased by multiple training passes.

Data shuffling is a training parameter designed to prevent the machine learning algorithm 1102 from reaching false optimal weights due to the order in which data contained in the training data set 1104 is processed. For example, data provided in rows and columns might be analyzed first row, second row, third row, etc., and thus an optimal weight might be obtained well before a full range of data has been considered. By data shuffling, the data contained in the training data set 1104 can be analyzed more thoroughly and mitigate bias in the resultant machine learning model 116.

Regularization is a training parameter that helps to prevent the machine learning model 116 from memorizing training data from the training data set 1104. In other words, the machine learning model 116 fits the training data set 1104, but the predictive performance of the machine learning model 116 is not acceptable. Regularization helps the machine learning system 110 avoid this overfitting/memorization problem by adjusting extreme weight values of the features 1106. For example, a feature that has a small weight value relative to the weight values of the other features in the training data set 1104 can be adjusted to zero.

The machine learning system 1100 can determine model accuracy after training by using one or more evaluation data sets 1108 containing the same features 1106′ as the features 1106 in the training data set 1104. This also prevents the machine learning model 116 from simply memorizing the data contained in the training data set 1104. The number of evaluation passes made by the machine learning system 1100 can be regulated by a target model accuracy that, when reached, ends the evaluation process and the machine learning model 116 is considered ready for deployment.

After deployment, the machine learning model 116 can perform prediction 1112 with an input data set 1110 having the same features 1106″ as the features 1106 in the training data set 1104 and the features 1106′ of the evaluation data set 1108. The results of the prediction 1112 are included in an output data set 1114 consisting of predicted data. The machine learning model 116 can perform other operations, such as regression, classification, and others. As such, the example illustrated in FIG. 11 should not be construed as being limiting in any way.

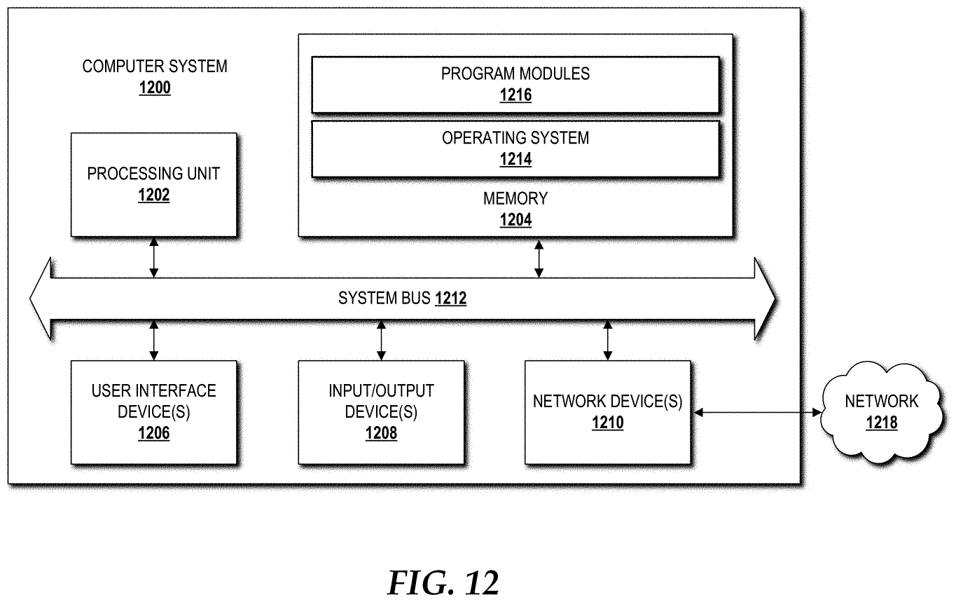

Turning now to FIG. 12, a block diagram illustrating a computer system 1200 configured to provide the functionality in accordance with various embodiments of the concepts and technologies disclosed herein. It should be understood, however, that modification to the architecture may be made to facilitate certain interactions among elements described herein. In some embodiments, the design studio 102, the composition engine 120, the blueprint deployer 134, the run time model connector 142, any user/designer/modeler systems, and other systems disclosed herein can be implemented, at least in part, by the computer system 1200.

The computer system 1200 includes a processing unit 1202, a memory 1204, one or more user interface devices 1206, one or more input/output (“I/O”) devices 1208, and one or more network devices 1210, each of which is operatively connected to a system bus 1212. The bus 1212 enables bi-directional communication between the processing unit 1202, the memory 1204, the user interface devices 1206, the I/O devices 1208, and the network devices 1210.

The processing unit 1202 may be a standard central processor that performs arithmetic and logical operations, a more specific purpose programmable logic controller (“PLC”), a programmable gate array, or other type of processor known to those skilled in the art and suitable for controlling the operation of the server computer. Processing units are generally known, and therefore are not described in further detail herein.

The memory 1204 communicates with the processing unit 1202 via the system bus 1212. In some embodiments, the memory 1204 is operatively connected to a memory controller (not shown) that enables communication with the processing unit 1202 via the system bus 1212. The illustrated memory 1204 includes an operating system 1214 and one or more program modules 1216. The operating system 1214 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, OS X, and/or iOS families of operating systems from APPLE CORPORATION, the FREEBSD family of operating systems, the SOLARIS family of operating systems from ORACLE CORPORATION, other operating systems, and the like.

The program modules 1216 may include various software and/or program modules to perform the various operations described herein. The program modules 1216 and/or other programs can be embodied in computer-readable media containing instructions that, when executed by the processing unit 1202, perform various operations such as those described herein. According to embodiments, the program modules 1216 may be embodied in hardware, software, firmware, or any combination thereof.

By way of example, and not limitation, computer-readable media may include any available computer storage media or communication media that can be accessed by the computer system 1200. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 1200. In the claims, the phrase “computer storage medium” and variations thereof does not include waves or signals per se and/or communication media.

The user interface devices 1206 may include one or more devices with which a user accesses the computer system 1200. The user interface devices 1206 may include, but are not limited to, computers, servers, PDAs, cellular phones, or any suitable computing devices. The I/O devices 1208 enable a user to interface with the program modules 1216. In one embodiment, the I/O devices 1208 are operatively connected to an I/O controller (not shown) that enables communication with the processing unit 1202 via the system bus 1212. The I/O devices 1208 may include one or more input devices, such as, but not limited to, a keyboard, a mouse, or an electronic stylus. Further, the I/O devices 1208 may include one or more output devices, such as, but not limited to, a display screen or a printer.

The network devices 1210 enable the computer system 1200 to communicate with other networks or remote systems via a network 1218. Examples of the network devices 1210 include, but are not limited to, a modem, a radio frequency (“RF”) or infrared (“IR”) transceiver, a telephonic interface, a bridge, a router, or a network card. The network 1218 may include a wireless network such as, but not limited to, a Wireless Local Area Network (“WLAN”), a Wireless Wide Area Network (“WWAN”), a Wireless Personal Area Network (“WPAN”) such as provided via BLUETOOTH technology, a Wireless Metropolitan Area Network (“WMAN”) such as a WiMAX network or metropolitan cellular network. Alternatively, the network 1218 may be a wired network such as, but not limited to, a Wide Area Network (“WAN”), a wired Personal Area Network (“PAN”), or a wired Metropolitan Area Network (“MAN”).

Based on the foregoing, it should be appreciated that to systems, methods, and computer-readable media for designing, creating, and deploying composite machine learning applications in cloud environments have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

We claim:

1. A system comprising:
a processor; and
memory having instructions stored thereon that, when executed by the processor, cause the processor to perform operations comprising
presenting a design studio canvas upon which a user can design a composite machine learning application from at least one of a plurality of building blocks stored in a design studio catalog,
receiving input to design, on the design studio canvas, a visual representation of the composite machine learning application,
saving the visual representation of the composite machine learning application, and
in response to saving the visual representation of the composite machine learning application, generating a composition dump file comprising a graph structure of the composite machine learning application.

2. The system of claim 1, wherein the plurality of building blocks comprise a plurality of machine learning models.

3. The system of claim 2, wherein the plurality of building blocks further comprise a data collection function.

4. The system of claim 3, wherein the plurality of building blocks further comprise a data transformation function.

5. The system of claim 2, wherein the operations further comprise validating the composition dump file based upon a validation rule.

6. The system of claim 5, wherein the operations further comprise:
generating, from the composition dump file, a blueprint file for the composite machine learning application; and
storing the blueprint file in a repository.

7. The system of claim 6, wherein the operations further comprise deploying, based upon the blueprint file, the composite machine learning application on a target cloud environment.

8. A method comprising:
presenting, by a system comprising a processor and memory, a design studio canvas upon which a user can design a composite machine learning application from at least one of a plurality of building blocks stored in a design studio catalog;
receiving, by the system, input to design, on the design studio canvas, a visual representation of the composite machine learning application;
saving, by the system, the visual representation of the composite machine learning application; and
in response to saving the visual representation of the composite machine learning application, generating, by the system, a composition dump file comprising a graph structure of the composite machine learning application.

9. The method of claim 8, wherein the plurality of building blocks comprise a plurality of machine learning models.

10. The method of claim 9, wherein the plurality of building blocks further comprise a data collection function.

11. The method of claim 10, wherein the plurality of building blocks further comprise a data transformation function.

12. The method of claim 9, further comprising validating the composition dump file based upon a validation rule.

13. The method of claim 12, further comprising:
generating, from the composition dump file, a blueprint file for the composite machine learning application; and
storing the blueprint file in a repository.

14. The method of claim 13, wherein the operations further comprise deploying, based upon the blueprint file, the composite machine learning application on a target cloud environment.

15. A computer-readable storage medium having computer-executable instructions stored thereon that, when executed by a processor, cause the processor to perform operations comprising:
presenting a design studio canvas upon which a user can design a composite machine learning application from at least one of a plurality of building blocks stored in a design studio catalog;
receiving input to design, on the design studio canvas, a visual representation of the composite machine learning application;
saving the visual representation of the composite machine learning application; and
in response to saving the visual representation of the composite machine learning application, generating a composition dump file comprising a graph structure of the composite machine learning application.

16. The computer-readable storage medium of claim 15, wherein the plurality of building blocks comprise a plurality of machine learning models.

17. The computer-readable storage medium of claim 16, wherein the plurality of building blocks further comprise a data collection function.

18. The computer-readable storage medium of claim 17, wherein the plurality of building blocks further comprise a data transformation function.

19. The computer-readable storage medium of claim 16, wherein the operations further comprise validating the composition dump file based upon a validation rule.

20. The computer-readable storage medium of claim 19, wherein the operations further comprise:
generating, from the composition dump file, a blueprint file for the composite machine learning application;
storing the blueprint file in a repository; and
deploying, based upon the blueprint file, the composite machine learning application on a target cloud environment.
